(19) United States
(12) Patent Application Publication
(10) Pub. No.: US 2009/0091669 A1
(43) Pub. Date: Apr. 9, 2009

(54) MULTI-DOMAIN LIQUID CRYSTAL DISPLAY AND ARRAY SUBSTRATE THEREOF

(76) Inventors: WEN-CHUN WANG, TAICHUNG CITY (TW); CHIN-CHANG LIU, TAICHUNG COUNTY (TW)

Correspondence Address: Muncy, Geissler, Olds & Lowe, PLLC, P.O. BOX 1364, FAIRFAX, VA, 22038-1364, US

(21) Appl. No.: 12/244,525

(22) Filed: Oct. 2, 2008

(30) Foreign Application Priority Data
Oct. 4, 2007 (TW) 096137197

(51) Int. Cl. G02F 1/1343; G02F 1/1335; G02F 1/133

(52) U.S. Cl. 349/37; 349/139; 349/114

(57) ABSTRACT

An array substrate includes a transparent plate, a plurality of metallic signal lines, an insulating layer, a plurality of first and auxiliary electrodes, and a plurality of active components. The metallic signal lines are formed on the transparent plate, and the insulating layer is formed on the transparent plate and covers the metallic signal lines. The pixel electrodes are regularly arranged on the insulating layer, with a spacing region existing between two adjacent pixel electrodes. The auxiliary electrodes are provided on the insulating layer, and each auxiliary electrode is spread at least in the spacing region and at least partially surrounds one pixel electrode to produce fringe fields. The active components are connected between the metallic signal lines and the pixel electrodes.

### CROSS REFERENCE TO RELATED APPLICATION

This application claims priority of application No. 096137197 filed in Taiwan R.O.C on Oct. 4, 2007 under 35 U.S.C. §119; the entire contents of which are hereby incorporated by reference.

### BACKGROUND OF THE INVENTION

1. Field of the Invention

The invention relates to a multi-domain liquid crystal display and its array substrate.

2. Description of the Related Art

Typically, the display contrast ratio and response speed offered by a VA (vertically-aligned) mode liquid crystal display, which uses negative liquid crystal materials and vertical alignment films, are better than a TN (twisted-nematic) mode LCD, since liquid crystal molecules are aligned in a vertical direction when no voltage is applied. Also, it is known the viewing angle performance of a VA mode LCD is improved by setting the orientation directions of the liquid crystal molecules inside each picture element to a plurality of mutually different directions; that is, forming multiple distinct domains in the liquid crystal display.

FIG. 1A shows a schematic diagram illustrating a conventional design of a multi-domain vertically aligned liquid crystal display (MVA LCD). Referring to FIG. 1A, a top substrate 102 and a bottom substrate 104 are both provided with protrusions 106 having different inclined surfaces and covered by vertical alignment films 108. Hence, the liquid crystal molecules 112 near the inclined surfaces orientate vertically to the inclined surfaces to have different degrees of pre-tilt angles. In case the pre-tilt liquid crystal molecules exist, surrounding liquid crystal molecules 112 are tilted in the directions of the pre-tilt liquid crystal molecules 112 when a voltage is applied. Thus, multiple domains each having individual orientation direction of liquid crystal molecules 112 are formed. Besides, the domain-regulating structure for providing inclined surfaces includes, but is not limited to, the protrusions 106, and other structure such as a concave structure 114 shown in FIG. 1B may also be used.

However, when one compares the optical path of light I1 and that of light I2 shown both in FIGS. 1A and 1B, it is clearly found the tilted liquid crystal molecules through which the light I2 passes under a field-off state may result in a non-zero phase difference (nd≠0) to cause light leakage. Accordingly, additional compensation films must be provided to eliminate the light leakage.

FIG. 2 shows a schematic diagram illustrating another conventional design of an MVA LCD. Referring to FIG. 2, the transparent electrode 204 on the substrate 202 is provided with slits 206. Because of the fringe fields produced at edges of transparent electrode 204 and at each slit 206, the liquid crystal molecules 208 are tilted toward the center of each slit 206 to result in a multi-domain liquid crystal (LC) cell. However, the strength of the fringe fields generated by the formation of the slits 206 is often insufficient, particularly when the widths and the intervals of the slits 206 are not optimized. Besides, since the azimuth in which the liquid crystal molecules tilt due to fringe fields includes all directions of 360 degrees, a disclination region 210 often appears beyond the slits 206 or between two adjacent slits 206 to result in a reduced light transmittance.

Further, the multi-domain technique is typically used in either a transmission type or a reflection type LCD device. Though the transmission type LCD device uses backlight to obtain a bright display independent of surrounding environments, the panel brightness is often not sufficient when the device is exposed to direct sunlight. In comparison, a reflection type LCD device employs surrounding light to effect a display so that a backlight source is omitted; however, the reflection type LCD device is largely deteriorated in visibility in a dark surrounding. Hence, there has been a strong demand for designing a multi-domain LCD device that possesses good visibility in any environment and may overcome the disadvantages of conventional designs.

### BRIEF SUMMARY OF THE INVENTION

The invention provides a multi-domain liquid crystal display capable of solving the problems of conventional designs.

According to an embodiment of the invention, a multi-domain liquid crystal display includes a first and a second transparent substrates facing to each other, a liquid crystal layer, a common electrode, a first metal layer, a first dielectric layer, a second metal layer, a second dielectric layer, a third metal layer, and a plurality of pixel electrodes. The common electrode is provided on the first transparent substrate, and the first metal layer is formed on the second transparent substrate. The first dielectric layer is formed on the second transparent substrate and covers the first metal layer, and the second metal layer is formed on the first dielectric layer. The second dielectric layer is formed on the first dielectric layer and covers the second metal layer, and the third metal layer is formed on the second dielectric layer. The pixel electrodes are regularly arranged on the second dielectric layer, with a spacing region existing between two adjacent pixel electrodes. The third metal layer is patterned to form a plurality of auxiliary electrodes, and each auxiliary electrode is spread at least in the spacing region and at least partially surrounds one pixel electrode to produce fringe fields.

According to another embodiment of the invention, an array substrate includes a transparent plate, a plurality of metallic signal lines, a insulating layer, a plurality of first and auxiliary electrodes, and a plurality of active components. The metallic signal lines are formed on the transparent plate, and the insulating layer is formed on the transparent plate and covers the metallic signal lines. The pixel electrodes are regularly arranged on the insulating layer, with a spacing region existing between two adjacent pixel electrodes. The auxiliary electrodes are provided on the insulating layer, and each auxiliary electrode is spread at least in the spacing region and at least partially surrounds one pixel electrode to produce fringe fields. The active components are connected between the metallic signal lines and the pixel electrodes.

According to the above embodiments, a multi-domain profile of a LC cell is formed by providing conductive patterns on the insulating layer, which are easily formed through typical TFT fabrication processes. Hence, compared with the conventional design where a protrusion or via structure is used to cause tilted liquid crystal molecules, the residue phase difference is eliminated to avoid light leakage according to this embodiment since all liquid crystal molecules are vertically aligned under a field-off state. Further, compared with another conventional design where slits are formed to produce fringe fields, the biased auxiliary electrodes allow for stronger field strength to tilt liquid crystal molecules so as to reduce the areas of a disclination region and thus increase the light-transmittance of an LCD. Further, since the pixel electrodes and auxiliary electrodes may be formed on an insulating layer, the aperture ratio of pixels is improved and a coupling capacitance formed between transparent electrodes and neighboring signal lines is reduced. Besides, in case the auxiliary electrodes are made of metallic materials, the gap between each pixel electrode and neighboring auxiliary electrodes is reduced to increase the active display area.

### BRIEF DESCRIPTION OF THE DRAWINGS

FIG. 1A shows a schematic diagram illustrating a conventional design of a multi-domain vertically aligned liquid crystal display.

FIG. 1B shows a schematic diagram illustrating another conventional design of a multi-domain vertically aligned liquid crystal display.

FIG. 2 shows a schematic diagram illustrating another conventional design of a multi-domain vertically aligned liquid crystal display.

FIG. 3 shows a partial cross-section illustrating a multi-domain liquid crystal display (multi-domain LCD) according to an embodiment of the invention.

FIGS. 4A-4C show schematic diagrams respectively illustrating a dot inversion, a column inversion, and a row inversion polarity patterns under a polarity inversion drive scheme.

FIGS. 5A and 5B show schematic diagrams illustrating a multi-domain LCD according to an embodiment of the invention, where FIG. 5A is a top view observed from the normal direction of an array substrate, and FIG. 5B is a cross-section taken along line A-A′ in FIG. 5A.

FIGS. 6A and 6B show schematic diagrams illustrating a multi-domain LCD according to another embodiment of the invention, where FIG. 6A is a top view observed from the normal direction of an array substrate, and FIG. 6B is a cross-section taken along line B-B′ in FIG. 6A.

FIG. 7 shows a schematic diagram according to another embodiment of the invention.

FIG. 8 shows a schematic diagram according to another embodiment of the invention.

FIG. 9 shows a schematic diagram according to another embodiment of the invention.

FIG. 10 shows a schematic diagram according to another embodiment of the invention.

FIG. 11 shows a schematic cross-section according to another embodiment of the invention.

FIG. 12 shows a schematic cross-section according to another embodiment of the invention.

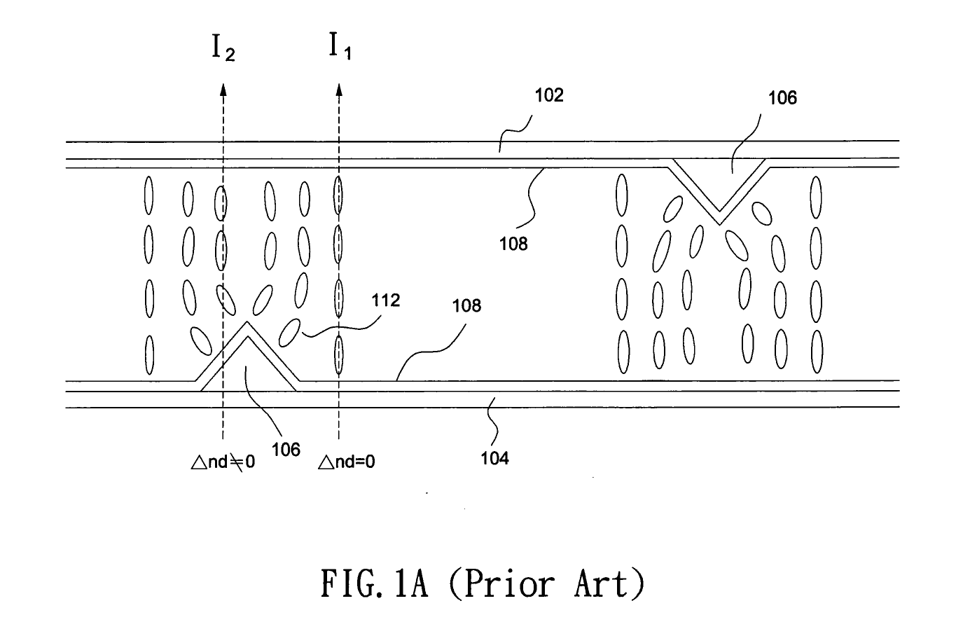

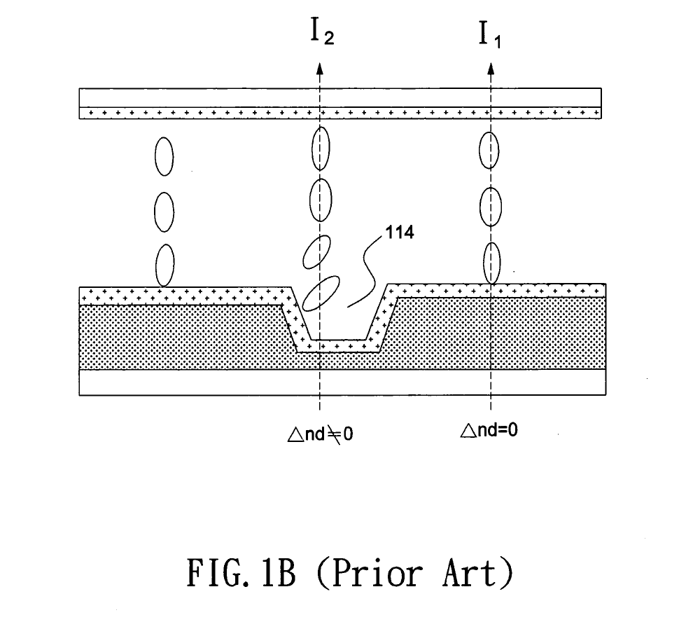

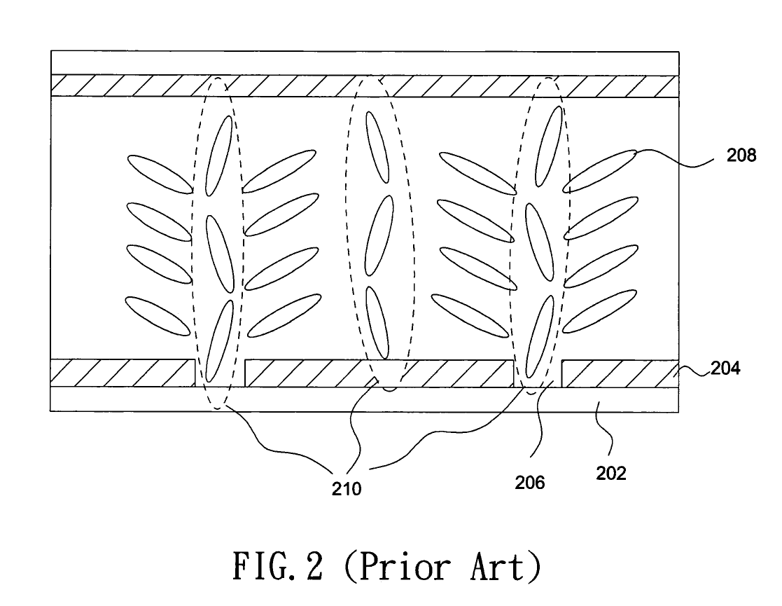

### DETAILED DESCRIPTION OF THE INVENTION

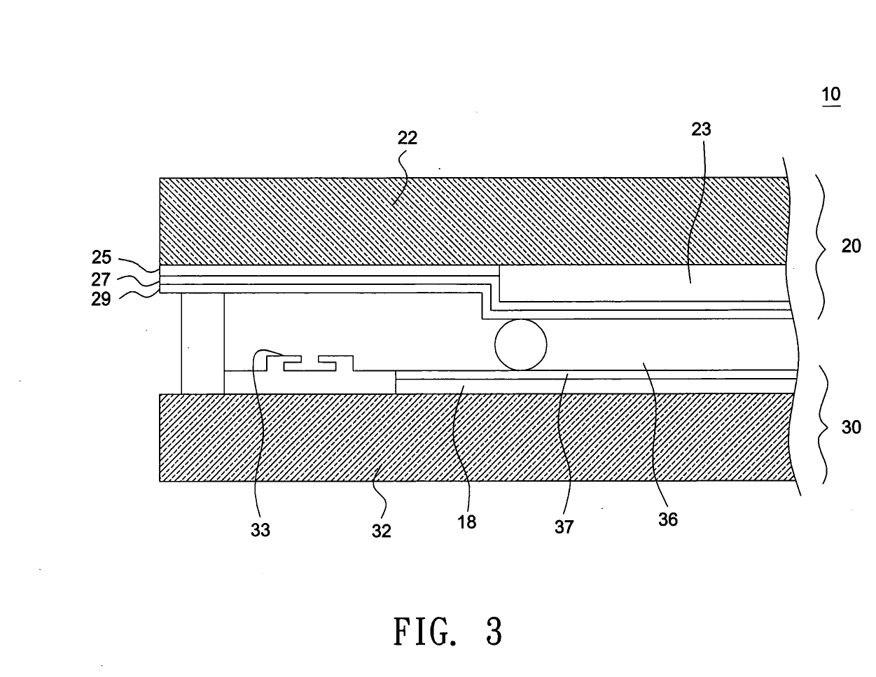

FIG. 3 shows a partial cross-section illustrating a multi-domain liquid crystal display (multi-domain LCD) according to an embodiment of the invention. Referring to FIG. 3, the multi-domain LCD 10 includes a color filter substrate 20 and an array substrate 30, with a liquid crystal layer 36 interposed between them. The liquid crystal layer 36 is made from a liquid crystal material having negative dielectric anisotropy, where the liquid crystal molecules are vertically-aligned without being applied with a voltage. Further, a chiral dopant may be added to the liquid crystal layer to adjust the twist pitch to a desired value so as to reduce the areas of a disclination region. In the color filter substrate 20, a color filter 23, a black matrix layer 25, a common electrode 27, and an alignment layer 29 are formed on a transparent substrate 22. In the array substrate 30, an active component such as a thin film transistor (TFT) 33, a pixel electrode 18, and an alignment layer 37 are formed on a transparent substrate 32. Further, each TFT 33 is connected to a pixel electrode 18 and metallic signal lines (not shown) such as a scan line and a data line.

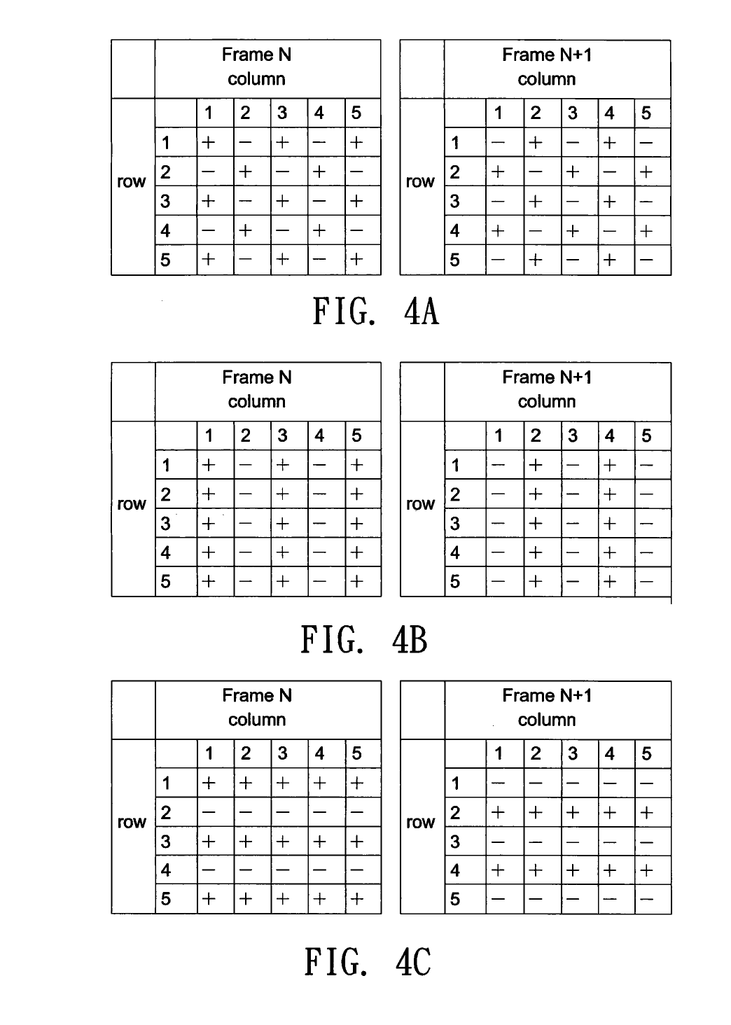

FIGS. 4A-4C show schematic diagrams respectively illustrating a dot inversion, a column inversion, and a row inversion polarity patterns under a polarity inversion drive scheme. It can be seen positive-polarity pixels and negative-polarity pixels alternate with each other in the horizontal direction (row direction) or in the vertical direction (column direction) under the same frame of a polarity inversion drive scheme.

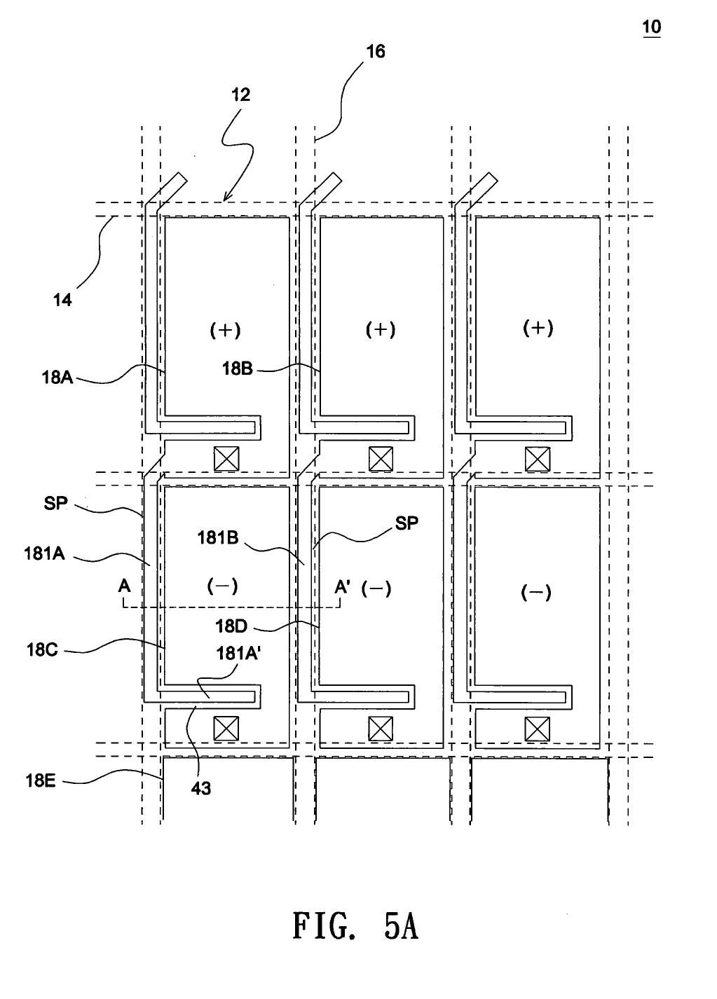

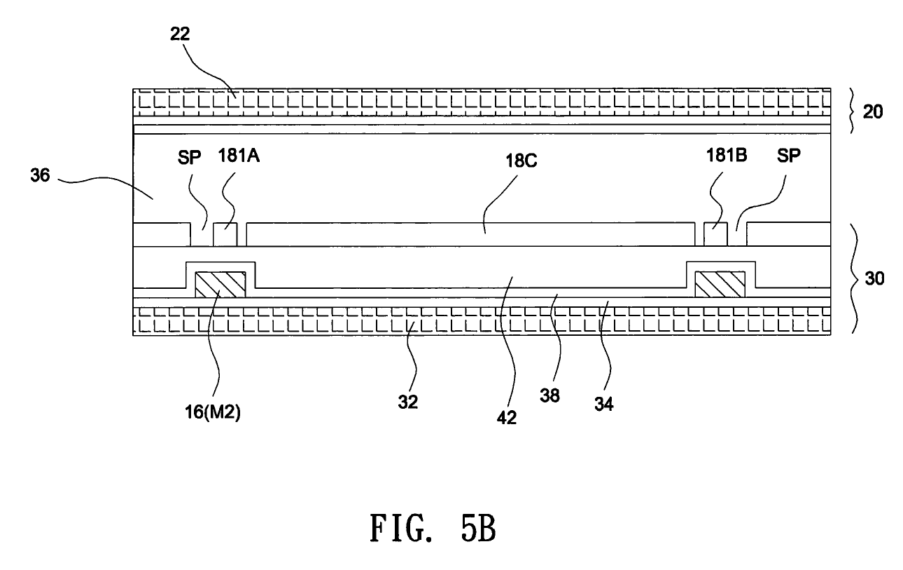

FIGS. 5A and 5B show schematic diagrams illustrating a multi-domain LCD 10 according to an embodiment of the invention, where FIG. 5A is a top view observed from the normal direction of an array substrate, and FIG. 5B is a cross-section taken along line A-A′ in FIG. 5A. Multiple metallic signal lines including scan lines 14 and data lines 16 are formed on the array substrate 30 to define an array of pixels. Each of the pixels 12 includes a pixel electrode 18 and an auxiliary electrode 181 that is electrically connected to one of adjacent pixel electrodes. In general, the scan lines 14 are formed from a first metal layer and the data lines 16 are formed from a second metal layer with a dielectric layer or insulating layer sandwiched between the first metal layer and the second metal layer. As shown in FIG. 5A, under a row-inversion drive scheme, the pixel electrodes 18A and 18B in one row have a positive polarity and the pixel electrode 18C and 18D in the adjacent row has a negative polarity. The pixel electrode 18A has an extension part 181A that extends to a spacing region SP on the left side of the pixel electrode 18C, and the pixel electrode 18B has an extension part 181B that extends to a spacing region SP on the right side of the pixel electrode 18C, wherein the spacing regions SP exist between two adjacent pixel electrodes. Hence, a different polarity exists between the pixel electrode 18C with a negative polarity and the surrounding extension parts 181A and 181B with a positive polarity to produce fringe fields, and the liquid crystal molecules with negative dielectric anisotropy are directed to a direction perpendicular to the slant electric filed. Under the circumstance, the orientations of liquid crystal molecules within one pixel are divided into different tilt directions. Further, according to this embodiment, a traverse slit 43 is formed on the lower part of each pixel electrode 18 at a position overlapping the interface between an active display area and a non-active display area on which a storage capacitor or TFT is spread, and the extension part 181A is bent to form a horizontally-extending section 181A′ that extends into the slit 43, so that a different polarity exists between the section 181A′ with a positive polarity and the pixel electrode 18C with a negative polarity to produce fringe fields. Besides, since the different polarity also exists between the pixel electrode 18C (negative polarity) and the pixel electrode 18A (positive polarity) over it to produce fringe fields, the resultant effect may create a four-domain profile of an LC cell.

Next, as shown in FIG. 5B, in the array substrate 30 a first metal layer M1 (not shown) is deposited on the transparent substrate 32 and patterned to define scan lines 14 shown in FIG. 5A. A dielectric gate insulation layer 34 is formed on the transparent substrate 32 and covers the first metal layer M1. A second metal layer M2 is deposited on the gate insulation layer 34 and patterned to define data lines 16. A dielectric passivation layer 38 and an insulating layer 42 are sequentially formed on the gate insulation layer 34 and cover the second metal layer M2. Generally, the insulating layer 42 is an organic insulating layer used for forming a planar layer. A transparent conductive layer is deposited on the insulating layer 42 and patterned to define multiple pixel electrodes 18 and auxiliary electrodes 181. Multiple pixel electrodes (such as 18A-18E shown in FIG. 5A) are regularly arranged on the insulating layer 42, with spacing regions SP existing between two adjacent pixel electrodes. The extension parts 181 A and 181B (positive polarity) located in the spacing region SP and over the data lines 16 function as auxiliary electrodes and partially surround the pixel electrode 18C (negative polarity) to produce fringe fields. According to this embodiment, since the pixel electrodes and auxiliary electrodes are formed on the insulating layer 42, the aperture ratio of pixels is improved and a coupling capacitance formed between transparent electrodes and neighboring signal lines (such as data lines 16) is reduced.

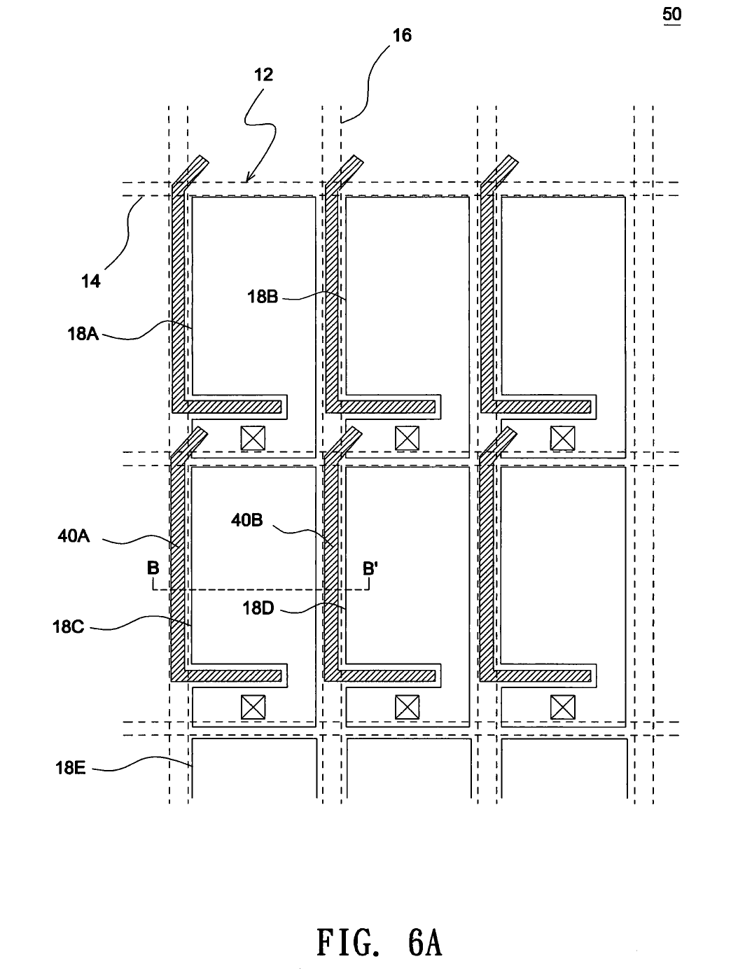

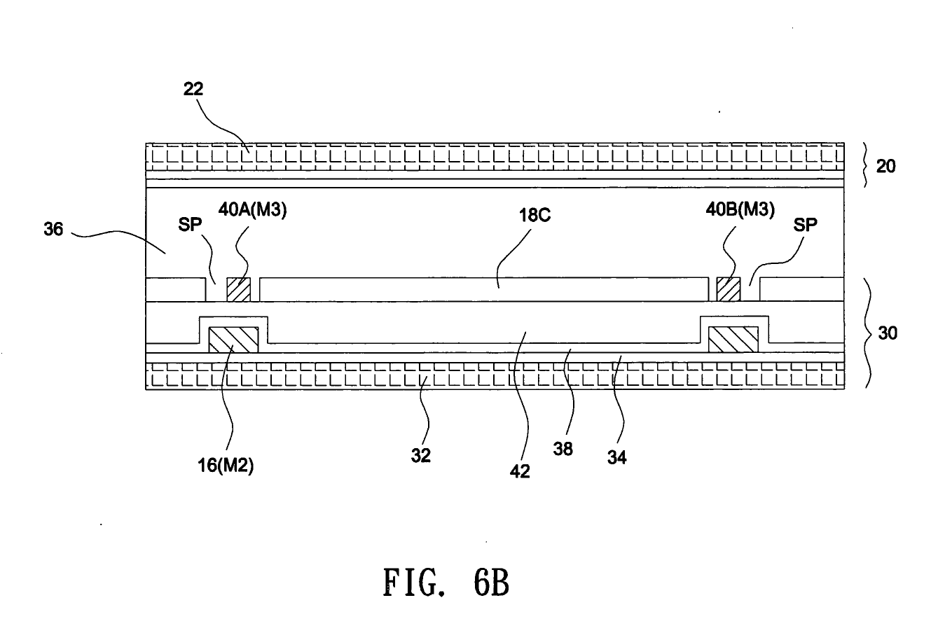

FIGS. 6A and 6B show schematic diagrams illustrating a multi-domain LCD 50 according to another embodiment of the invention, where FIG. 6A is a top view observed from the normal direction of an array substrate, and FIG. 6B is a cross-section taken along line B-B′ in FIG. 6A. As shown in FIGS. 6A and 6B, after the passivation layer 38 and the insulating layer 42 are sequentially formed on the gate insulation layer 34 and cover the second metal layer M2, a transparent conductive layer together with a third metal layer M3 are deposited on the insulating layer 42. The transparent conductive layer is patterned to define multiple regularly-arranged pixel electrodes (such as 18A-18E shown in FIG. 5A), and the third metal layer M3 is patterned to define multiple auxiliary electrodes (such as 40A and 40B) spread in each spacing region SP between two adjacent pixel electrodes. Further, the metallic auxiliary electrodes 40A and 40B are connected to an adjacent pixel electrode 18 controlled by a preceding-stage scan line to allow the auxiliary electrodes 40A and 40B to have the same polarity as that connected pixel electrode 18. Hence, each pixel electrode 18C and the auxiliary electrodes 40A and 40B that partially surround the pixel electrode 18c have opposite polarities to produce fringe fields. Since the metal layer and the transparent conductive layer are made of different materials, the gap between each pixel electrode 18 and neighboring auxiliary electrodes 40 is reduced to increase the active display area.

According to the above embodiments, a multi-domain profile of a LC cell is formed by providing conductive patterns (pixel electrodes and auxiliary electrodes) on the insulating layer 42, which are easily formed through typical TFT fabrication processes. Hence, compared with the conventional design where a protrusion or via structure is used to cause tilted liquid crystal molecules, the residue phase difference is eliminated to avoid light leakage according to this embodiment since all liquid crystal molecules are vertically aligned under a field-off state. Further, compared with another conventional design where slits are formed to produce fringe fields, the biased auxiliary electrodes allow for stronger field strength to tilt liquid crystal molecules so as to reduce the areas of a disclination region and thus increase the light-transmittance of an LCD.

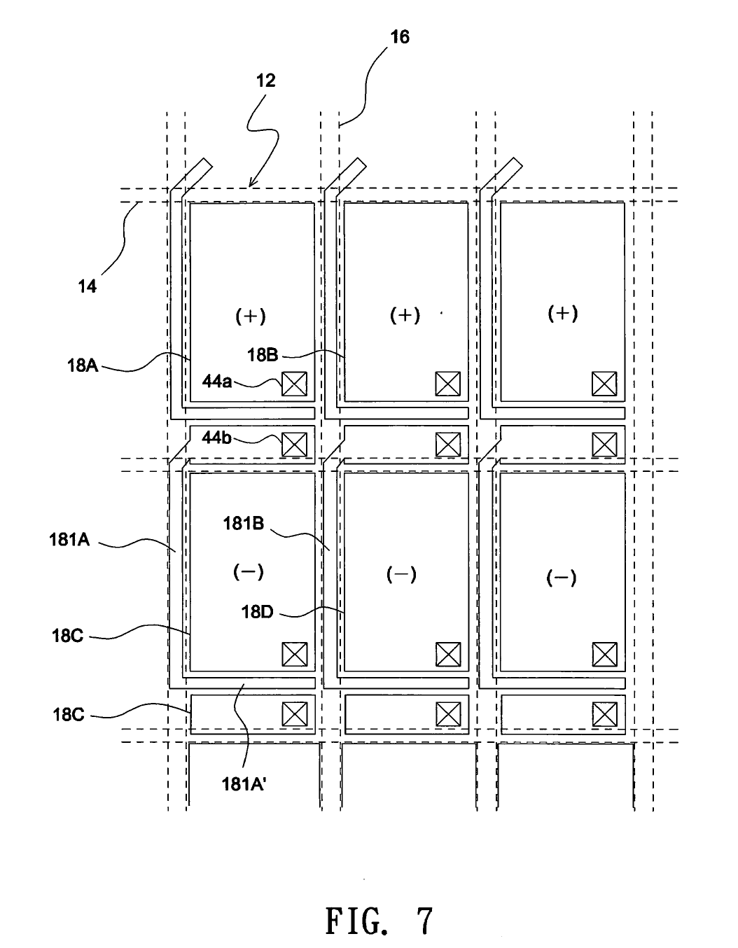

FIG. 7 shows a schematic diagram illustrating another embodiment of the invention. Referring to FIG. 7, the horizontally-extending section 181A′ of the auxiliary electrode 181A divides the pixel electrode 18C into two separate sections, so the horizontally-extending section 181A′ is next to an entire bottom side of the active display area of the pixel electrode 18C to enhance the strength of fringe fields. Further, in this embodiment, the auxiliary electrode 181A and the pixel electrode 18A that are separate from each other are electrically connected through via holes 44a and 44b, and the auxiliary electrode 181A may be made of transparent conductive materials or metallic materials. Therefore, the polarity of auxiliary electrode 181A is same as that of the pixel electrode 18A. That is, the auxiliary electrode 181A and the pixel electrode 18A both have positive polarity when the pixel electrode 18C have negative polarity.

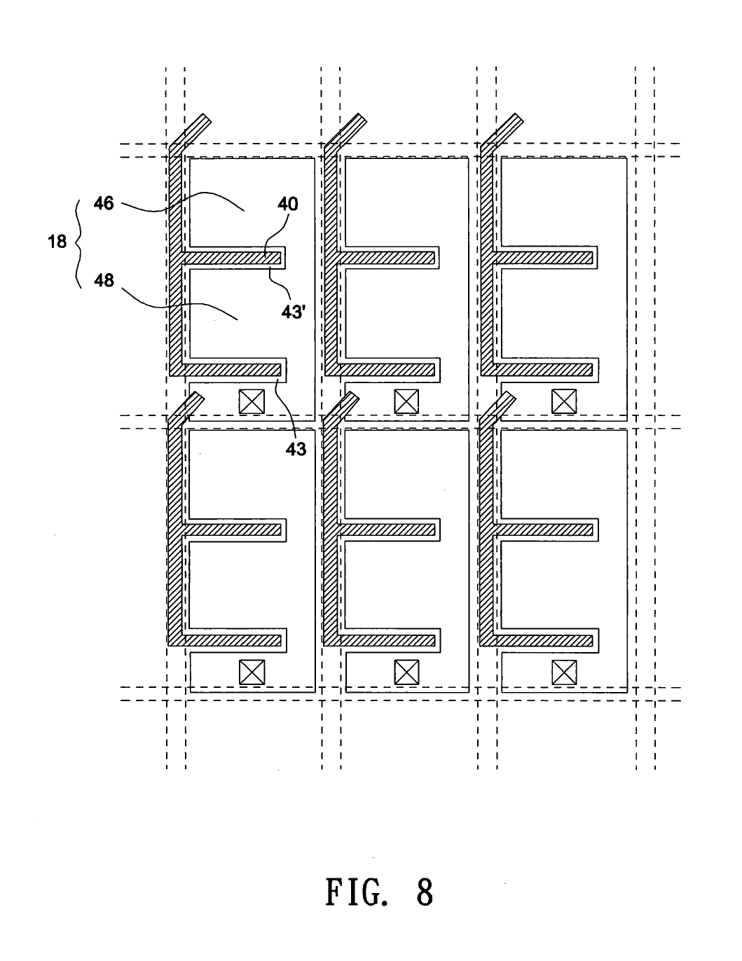

FIG. 8 shows a schematic diagram illustrating another embodiment of the invention. Referring to FIG. 8, the active display area of each pixel electrode 18 is divided into multiple sections through at least one slit 43′, such as two separate sections 46 and 48 shown in FIG. 8. An auxiliary electrode 40 is extended into the slit 43′ to at least partially surround each section of active display area to produce fringe fields. Note the division of the active display area of each pixel electrode 18 is not limited. Though the response time of liquid crystal molecules is reduced as the number of sections is increased, such division is not limited and is determined according to the actual demand. Besides, the distributions of auxiliary electrodes 40 and slits 43′ can be arbitrarily selected, as long as sufficient strength of fringe fields is obtained.

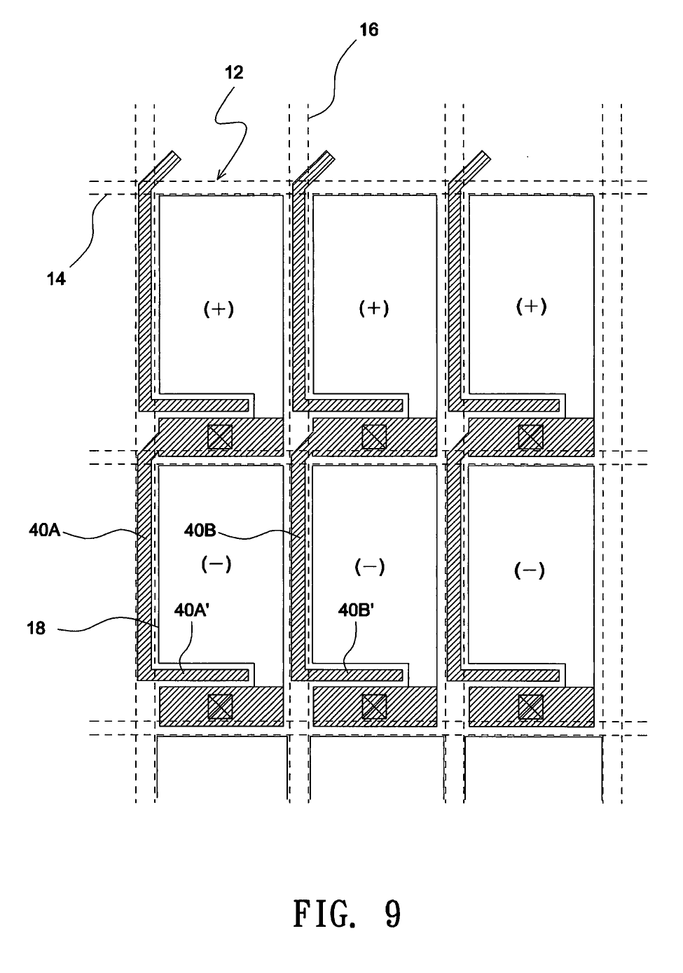

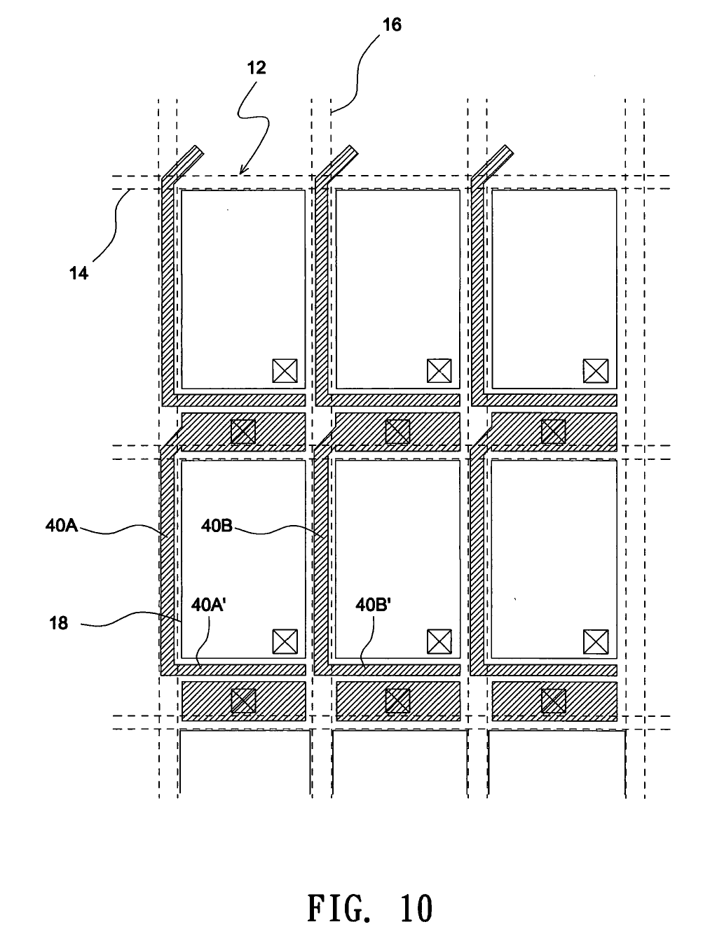

FIG. 9 shows a schematic diagram illustrating another embodiment of the invention. Referring to FIG. 9, in case the auxiliary electrodes 40A and 40B are made of metallic materials, they also serve a function of reflecting light and their distribution areas naturally constitute a reflective region of a pixel 12. In addition, the distribution areas of transparent pixel electrodes naturally constitute a transmissive region of a pixel, and thus a transflective display is achieved. Certainly, the distributions of reflective auxiliary electrodes 40A and 40B is not limited. For example, horizontally-extending sections 40A′ and 40B′ of the auxiliary electrodes 40A and 40B may not completely divide pixel electrode 18 (FIG. 9) or may completely divide pixel electrode 18 into two separate sections (FIG. 10).

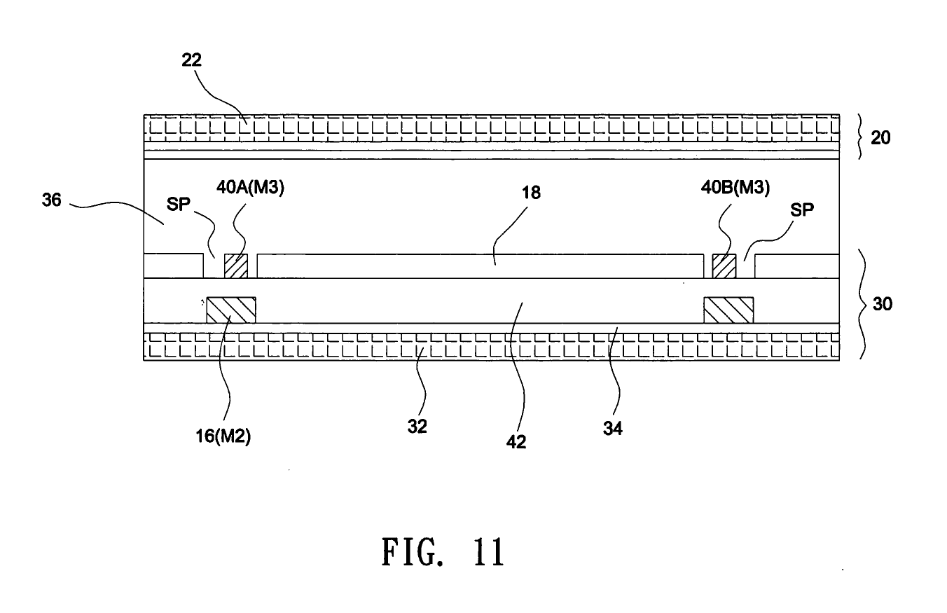

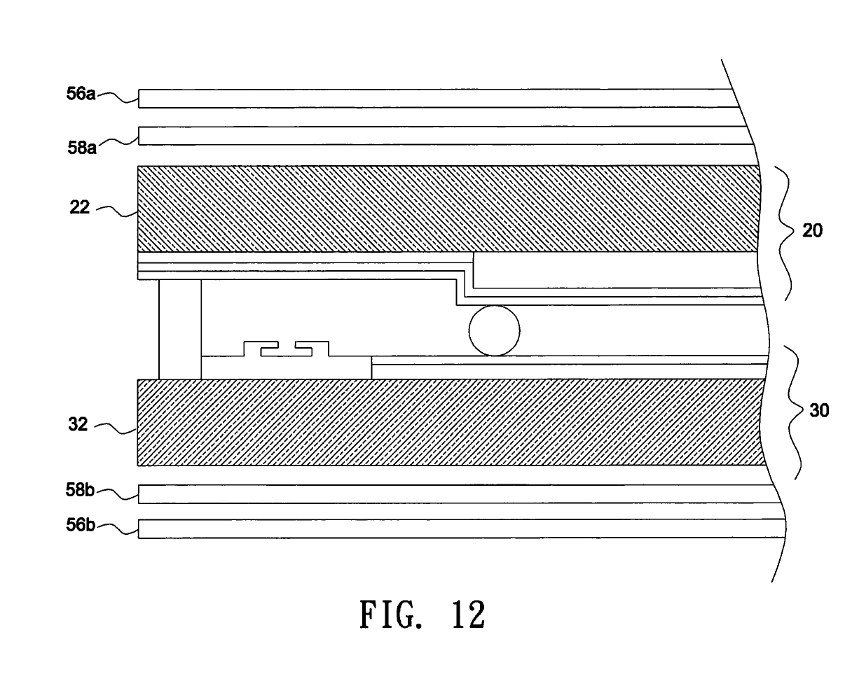

FIG. 11 shows a schematic diagram illustrating another embodiment of the invention. Referring to FIG. 11, the passivation layer 38 is omitted, and the insulating layer 42 is directly formed on the gate insulation layer 34 to cover the second metal layer M2 and to form a planer layer.

Besides, as shown in FIG. 12, a pair of quarter wavelength plates 58a and 58b are respectively provided between the transparent substrate 22 and a polarizer 56a and between the transparent substrate 32 and a polarizer 56b, so that a linear polarized liquid crystal cell is transformed into a circular polarized liquid crystal cell to improve light transmittance of the multi-domain LCD.

The foregoing description of the embodiments of the invention have been presented for purposes of illustration and description. They are not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. For example, the layout structure could also be tailored to column inversion or dot inversion drive scheme except for the row inversion drive scheme. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An array substrate, comprising:
a transparent plate;
a plurality of metallic signal lines that at least comprises scan lines and data lines formed on the transparent plate to define a plurality of pixels, each of the pixels comprises:
an insulating layer covering the data lines;
a pixel electrode provided on the insulating layer, with a plurality of spacing regions existing between the pixel electrode and adjacent pixel electrodes;
an auxiliary electrode provided on the insulating layer, wherein the auxiliary electrode is located at least in one of the spacing regions over the corresponding data line and at least partially surrounds the pixel electrode to produce fringe fields; and
an active component connected between the metallic signal lines and the pixel electrode;
wherein the auxiliary electrode is connected to one of the adjacent pixel electrodes and has a first polarity opposite to a second polarity of the pixel electrode.

2. The array substrate as claimed in claim 1, wherein the pixel electrodes and the auxiliary electrodes are made of transparent conductive materials.

3. The array substrate as claimed in claim 2, wherein each auxiliary electrode is an extension part of the adjacent pixel electrode controlled by a preceding-stage scan line.

4. The array substrate as claimed in claim 1, wherein the pixel electrodes are made of transparent conductive materials and the auxiliary electrodes are made of metallic materials.

5. The array substrate as claimed in claim 4, wherein the pixel electrode constitutes a transmissive region and the auxiliary electrode constitutes a reflective region.

6. The array substrate as claimed in claim 5, wherein the pixel electrode is provided with at least one slit that divides the pixel electrode into multiple sections and each section is at least partially surrounded by the auxiliary electrode to produce fringe fields.

7. The array substrate as claimed in claim 4, wherein the auxiliary electrode is connected to the adjacent pixel electrode controlled by a preceding-stage scan line through at least one via hole.

8. A multi-domain liquid crystal display, comprising:
a first and a second transparent substrates facing to each other;
a liquid crystal layer interposed between the first and the second transparent substrates;
a first metal layer formed on the second transparent substrate;
a first dielectric layer formed on the second transparent substrate and covering the first metal layer;
a second metal layer formed on the first dielectric layer;
a second dielectric layer formed on the first dielectric layer and covering the second metal layer;
a third metal layer formed on the second dielectric layer; and
a plurality of pixel electrodes regularly arranged on the second dielectric layer, with a spacing region existing between two adjacent pixel electrodes;
wherein the third metal layer is patterned to form a plurality of auxiliary electrodes, and each auxiliary electrode is located at least in the spacing region and at least partially surrounds one pixel electrode to produce fringe fields.

9. The multi-domain liquid crystal display as claimed in claim 8, wherein each pixel electrode and the auxiliary electrode that at least partially surrounds the pixel electrode have opposite polarities when a voltage is applied across the common electrode and the pixel electrodes.

10. The multi-domain liquid crystal display as claimed in claim 8, wherein the first dielectric layer comprises a gate insulation layer and the second dielectric layer comprises an organic insulating layer.

11. The multi-domain liquid crystal display as claimed in claim 8, wherein the first dielectric layer comprises a gate insulation layer and the second dielectric layer comprises a passivation layer and an insulating layer overlying the passivation layer.

12. The multi-domain liquid crystal display as claimed in claim 8, wherein each auxiliary electrode is connected to the pixel electrode controlled by a preceding-stage scan line through at least one via hole.

13. The multi-domain liquid crystal display as claimed in claim 8, wherein the distribution areas of the pixel electrodes constitute a transmissive region and the distribution areas of the auxiliary electrodes constitute a reflective region of the multi-domain liquid crystal display.

14. The multi-domain liquid crystal display as claimed in claim 8, wherein each pixel electrode is provided with at least one slit that divides the pixel electrode into multiple electrode sections, and each electrode section is at least partially surrounded by the auxiliary electrode to produce fringe fields.

15. The multi-domain liquid crystal display as claimed in claim 8, wherein the liquid crystal layer further comprises an additive of chiral dopant.

16. The multi-domain liquid crystal display as claimed in claim 8, further comprising:
a first polarizer positioned next to the first transparent substrate and opposite the liquid crystal layer;
a second polarizer positioned next to the second transparent substrate and opposite the liquid crystal layer;
a first quarter wavelength plate provided between the first polarizer and the first transparent substrate; and
a second quarter wavelength plate provided between the second polarizer and the second transparent substrate.

17. A multi-domain liquid crystal display, comprising:
a first and a second transparent substrates facing to each other;
a liquid crystal layer interposed between the first and the second transparent substrates;
multiple metallic signal lines provided on the second transparent substrate;
an insulating layer formed on the second transparent substrate and covering the metallic signal lines;
a plurality of pixel electrodes regularly arranged on the insulating layer, with a spacing region existing between two adjacent pixel electrodes; and
a plurality of auxiliary electrodes formed on the insulating layer, each auxiliary electrode being spread at least in the spacing region to cooperate with at least one neighboring pixel electrode to produce fringe fields;
wherein each of the pixel electrodes and the auxiliary electrode that at least partially surrounds the corresponding pixel electrode have opposite polarities under an row inversion, column inversion or an dot inversion drive scheme.
